(19) United States
(12) Patent Application Publication
(10) Pub. No.: US 2005/0099791 A1
(43) Pub. Date: May 12, 2005

(54) Backlighting system for liquid crystal displays

(75) Inventor: Uwe Nagel, Karlsruhe (DE)

Correspondence Address: SUGHRUE MION, PLLC, 2100 PENNSYLVANIA AVENUE, N.W., SUITE 800, WASHINGTON, DC, 20037, US

(73) Assignee: SIEMENS AKTIENGESELLSCHAFT

(21) Appl. No.: 10/922,957

(22) Filed: Aug. 23, 2004

(30) Foreign Application Priority Data
Aug. 22, 2003 (DE) 10338691.2

(51) Int. Cl. F21V 7/04

(52) U.S. Cl. 362/31

(57) ABSTRACT

A backlighting system for liquid crystal displays includes one or more first lighting structure (130, 230), which has a defined radiant flux with spectral color components at one operating point. The radiant flux output from the first lighting structure (130, 230) exits across a radiant surface (A) of the backlighting system and thus provides a defined luminous flux with spectral color components on a liquid crystal glass (10) that can be arranged in front of this radiant surface (A). Also, the backlighting system has one or more additional lighting structure (140, 240, 340). The radiant flux of the additional lighting structure varies. This additional lighting structure (140, 240, 340) is arranged such that the spectral color components of the luminous flux change when the radiant flux of the additional lighting structure (140, 240, 340) is changed. The liquid crystal display is used for controlling and monitoring in an automation system.

The following disclosure is based on German Patent Application No. 103 38 691.2, filed on Aug. 22, 2003, which is incorporated into this application by reference.

### FIELD AND BACKGROUND OF THE INVENTION

1. Field of the Invention

The present invention relates to a backlighting system for liquid crystal displays and to a liquid crystal display with the backlight system.

2. Description of Related Art

Liquid crystal displays and their use are generally known. Conventional cathode ray tube monitors are increasingly replaced by liquid crystal displays. Such liquid crystal displays, also referred to as LCD displays, are used, in particular, wherever space is limited.

Liquid crystal displays essentially consist of a so-called liquid crystal glass in which a number of liquid crystal elements are bound in a form of a suitable matrix between two sheets of glass. Depending on the type of liquid crystals used, monochrome or color LCD displays can be made. Since the liquid crystals are optically passive elements whose transmittance is controlled, suitable lighting structure must be provided. To control the transmittance of the optically passive elements, a backlighting system with a suitable lighting structure may be provided. For example, the lighting structure may be provided on the side of the liquid crystal glass that is opposite to the user. In the conventional LCD displays, it is known to use fluorescent lamps, such as CFL or CCFL lamps, or special xenon discharge lamps, which are also known under the name of Planon, made by Osram, e.g. see the journal “elektronik industrie,” vol. 6, pp. 90-91, 1999.

The backlighting system must be configured and arranged in such a way that it illuminates the liquid crystal glass completely and uniformly across the entire display area. To obtain complete and uniform illumination across the entire display area, a diffusing screen is usually provided between the lighting structure and the liquid crystal glass. This has the effect that a radiant flux, which is at least partially directional when it enters the diffusing screen from the lighting means, is rendered as non-directional as possible as it exits the diffusing screen. Thus, a uniformly flat illumination of the liquid crystal glass can be obtained and therefore the liquid crystal display is achieved. As perceived by the user, the luminance of the liquid crystal display is largely constant across the entire display area.

The radiant flux that is output from the lighting structure has different spectral color components depending on the nature of the lighting structure. In addition, the radiant flux from the lighting structure has different spectral color components depending on the operating point that has been set. In other words, depending on the voltage or current used to operate the lighting structure, not only the magnitude of the radiant flux changes but also the spectral color components in the radiant flux. However, due to manufacturing tolerances, the same lighting structure can have different spectral color components in its radiant flux for the same operating point. The resulting change of the spectral color components in the luminance results in the shift of the color location of the luminance, which is visible to the user.

Fluorescent lamps, such as the CCFL lamp or the Planon lamp, can only be operated at a defined operating point. As a result, it is not possible to compensate the shift in the color location of the luminance caused by manufacturing tolerances by a slight change in the operating point. Such color location shifts will be obvious and annoying to a user especially if several liquid crystal displays are arranged side by side, as is often the case, for example, in an automation system.

To avoid this drawback, it is necessary either to tighten the manufacturing tolerances of the lighting structure for the production of liquid crystal displays or to use only liquid crystal displays with small tolerances for automation systems. These techniques are expensive and time-consuming. As an alternative, an array of colored light emitting diodes can be used as a backlighting system instead of fluorescent lamps. This has the advantage that the operating point of the light emitting diode can be changed. By correspondingly controlling the individual color LEDs, the spectral color components in the radiant flux of the backlighting system can be changed and thus adjusted. However, such LED arrays are costly compared to the relatively inexpensive CCFL or Planon lamps, and today, LEDs from the blue light spectrum still have a relatively short service life.

### OBJECTS OF THE INVENTION

Thus, one object of the present invention is to provide a backlighting system that ensures a constant distribution of the spectral color components in the luminance of a liquid crystal display in a simple and effective way.

Illustrative, non-limiting embodiments of the present invention may overcome the above disadvantages and other disadvantages not described above. The present invention is not necessarily required to overcome any of the disadvantages described above, and the illustrative, non-limiting embodiments of the present invention may not overcome any of the problems described above. The appended claims should be consulted to ascertain the true scope of the invention.

### SUMMARY OF THE INVENTION

According to the exemplary, non-limiting embodiments of the present invention, a backlighting system for a liquid crystal display is provided. The backlighting system has one or more first lighting means for illuminating a liquid crystal glass. The first lighting means has a defined radiant flux with spectral color components at a first operating point. The defined radiant flux output from the first lighting means exits across a first radiant surface of the backlighting system and results in a defined luminous flux with spectral color components on the liquid crystal glass that can be arranged in front of this radiant surface. Moreover, the backlighting system has one or more additional lighting means for illuminating the liquid crystal glass. The additional lighting means has a variable radiant flux and is arranged in such a way that the spectral color components of the luminous flux change when the radiation flux of the additional lighting means is changed.

By providing, in addition to an existing first lighting means with a fixed operating point, at least one additional, suitably arranged lighting means whose radiant flux is variable, it is possible to change the spectral color components in the luminance of the liquid crystal display. The arrangement of the one or more additional lighting means should be such that a uniform change in the color components is ensured across the entire display area of the liquid crystal display. This makes it possible to use low-cost lighting means, which furthermore have a fixed operating point, as the first lighting means for the backlighting system of liquid crystal displays. The manufacturing tolerances that occur in the first lighting means are then readily compensated by additional variable lighting means. With the backlighting system according to the exemplary, non-limiting embodiments of the present invention, liquid crystal displays are provided, in which the luminous flux and thus the luminance have the same color location. As a result, the same visual impression is imparted to the user, particularly when side-by-side liquid crystal displays is configured to control and monitor in automation systems.

Preferably, fluorescent lamps, particularly CCFL or Planon lamps, are used as the first lighting means. They are inexpensive and have good properties for the illumination of liquid crystal displays.

Since the second lighting means is provided to compensate manufacturing tolerances of the first lighting means, the variable radiant flux of the additional lighting means can be smaller than the radiant flux of the first lighting means. As a result, the amount of the radiant flux and thus the luminous flux is essentially determined by the first lighting means.

The additional lighting means can be light emitting diodes, which are inexpensive to procure and very easy to arrange because of their small size. In particular, light emitting diodes in the yellow or red spectral range may be provided. A plurality of light emitting diodes with different spectral color components may be provided. The color components are mixed using a corresponding control.

According to another exemplary, non-limiting embodiment of the present invention, a liquid crystal display is provide. The liquid crystal display has a liquid crystal glass and a backlighting system with a first and a second lamp. The first lamp has a defined radiant flux with spectral color components at a first operating point. The radiant flux output from the first lamp exits across a first radiant surface of the backlighting system and results in a defined luminous flux with spectral color components on the liquid crystal glass that can be arranged in front of this radiant surface. The second lamp has a variable radiant flux and is arranged such that the spectral color components of the luminous flux change when the radiation flux of the additional lighting means is changed. The liquid crystal glass is configured such that colored pictures or monochrome pictures are displayed. This display is influenced by the spectral color components of the luminous flux that are caused by the radiant flux of the first and second lamps.

Moreover, the second lamp may be provided in a light box along with the first lamp. Alternatively, the second lamp may be positioned on a side wall of the first lamp or it can even be coupled to a diffusing screen. The diffusing screen scatters the radiant flux of the first lamp. Finally, other locations for positioning the second lamp are possible. Also, any combinations of the above-named positions are possible.

### BRIEF DESCRIPTION OF THE DRAWINGS

The above and other features and advantages of the present invention will become more apparent by describing in detail illustrative, non-limiting embodiments thereof with reference to the attached drawings in which:

FIG. 1 shows a liquid crystal display with a backlighting system according to the first exemplary, non-limiting embodiment of the present invention,

FIG. 2 shows a liquid crystal display with a backlighting system according to the second exemplary, non-limiting embodiment of the present invention, and

FIG. 3 shows a liquid crystal display with a backlighting system according to the third exemplary, non-limiting embodiment of the present invention.

### DETAILED DESCRIPTION OF THE PREFERRED EMBODIMENTS

The present invention will now be described in detail by describing illustrative, non-limiting embodiments thereof with reference to the accompanying drawings._In the drawings, the same reference characters denote the same elements.

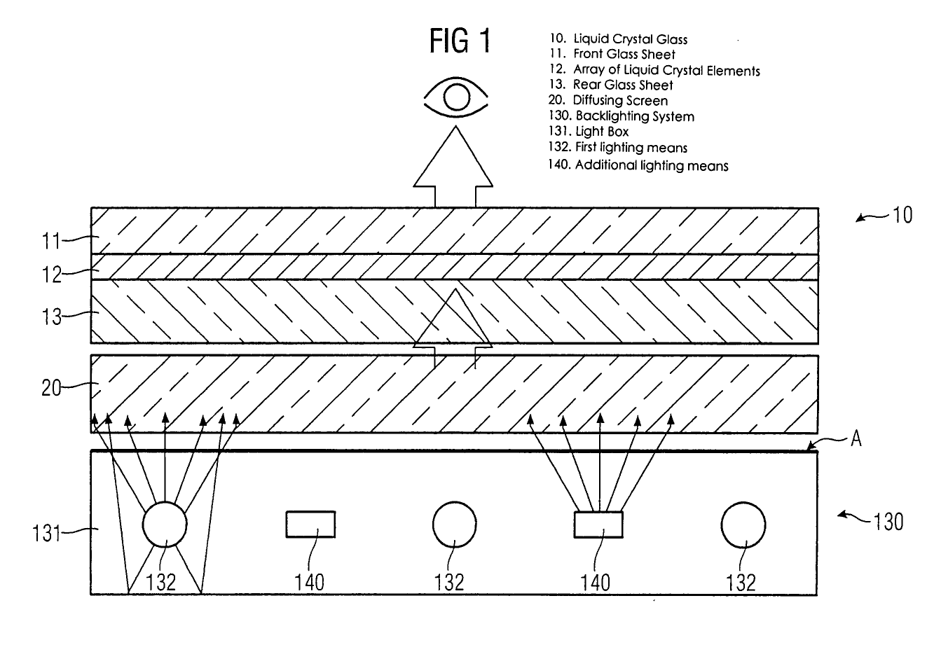

A liquid crystal displays, as illustrated in FIG. 1 has a liquid crystal glass 10 in which an array 12 of liquid crystal elements is sandwiched between a front glass sheet 11 and a rear glass sheet 13. The size, number and arrangement of the liquid crystal elements determine the display area for representing an image. To display images, the transmittance of the individual liquid crystal elements is controlled. The details regarding the structure of the liquid crystal glass 10, their control and the representation of images by means of such liquid crystal displays will not be further explained here. These details are generally known and do not significantly contribute to the concept of the present invention.

Usually, a backlighting system 130 or 230 is located directly behind the liquid crystal glass 10. The function of this backlighting system is to illuminate the rear side of the liquid crystal glass 10, i.e., the rear glass sheet 13, as uniformly as possible. To accomplish uniform luminance, a first lighting means 132 or 230 is provided, which, depending on the operating point set and the lighting means used, have a radiant flux with a corresponding distribution of the spectral color components. In FIGS. 1 to 3, the radiant flux is represented by light beams. In the backlighting system 130, 230, the light beams are directed in such a way that they exit from the backlighting system 130 or 230 on a radiant surface A. The radiant flux exiting from the radiant surface is perceived by the user as a luminous flux, or rather as luminance of the surface A. To ensure that this radiant flux illuminates the display area completely and uniformly, a diffusing screen 20 is typically provided between the surface A and the rear glass sheet 13 of the liquid crystal glass 10. This diffusing screen 20 causes the radiant flux exiting from the radiant surface A, still directional in part, to be further scattered and be largely non-directional as it enters the liquid crystal glass 10. In all three figures, a large arrow indicates the resultant non-directional luminous flux, which is uniformly distributed across the display area. So far, the diffusing screen 20 has only been described as an element that is separate from the backlighting system 130, 230. It can also form a part of the backlighting system 130, 230 if it is permanently applied to the radiant surface A of the backlighting system 130, 230.

The radiant flux passing through the liquid crystal glass 10 from the rear and the luminous flux caused thereby present a uniformly illuminated picture to the user, who is facing the front glass sheet 11. Depending on the backlighting system used, the luminous flux seen by the user has corresponding spectral color components. Ideally, the spectral color components should be distributed in such a way that the luminous flux has a defined color location, especially for the white color. The color location of the luminous flux is essentially determined by the spectral color components in the radiant flux of the lighting means used for the backlighting system.

For reasons of cost, fluorescent lamps, e.g., CCFL or Planon lamps are typically used today as backlighting systems for a liquid crystal display. They have the drawback, however, that they have only a single defined operating point and thus a defined radiant flux with spectral color components. Depending on the allowable manufacturing tolerances, these lamps exhibit variations in the spectral color components for the same operating point. Because of the different color components, these variations cause a shift in the color location in the radiant flux seen by the user and are therefore perceived by the user as annoying.

To compensate for such shifts in the color location, which are allowable within certain manufacturing tolerances, the illustrative, non-limiting embodiment of the present invention provides for one or more additional lighting means 140, 240, 340. The additional lighting means are arranged in such a way that the radiant flux output from an additional lighting means 140, 240, 340 is mixed with the radiant flux of the first lighting means 130, 230. Because the variations caused by the manufacturing tolerances are rather small in the operating point relative to the amount of the radiant flux of the first lighting means 130, 230, it is usually sufficient to mix in a small radiant flux by using the additional lighting means 140, 240, 340 to compensate the tolerances in the color location of the luminous flux.

FIG. 1 shows a liquid crystal display with a backlighting system in accordance with a first, illustrative, non-limiting embodiment of the present invention. As illustrated in FIG. 1, the backlighting system 130 has a number of rod-shaped CCFL fluorescent lamps 132, which are arranged in a light box 131. The light box 131 causes the radiation coming from the lamps 132 to be directed such that the radiation exits the light box 131 on the radiant surface A. Multiple reflections and scattering of the beams on the sidewalls of the light box 131 and during the subsequent passage through the diffusing screen 20 cause the radiation from the lamps 132 to be mixed. The result is a luminous flux and in particular a luminance on the rear glass sheet 13, which uniformly illuminates the entire display area of the liquid crystal glass 10.

At every location of the display area and thus at every location of the image visible to the user, the luminous flux has approximately the same amount and the same ratio of spectral color components. If, as a result of manufacturing tolerances in the CCFL fluorescent lamps 132, the luminous flux has fewer spectral components of a particular color, e.g., red spectral components, the resulting shift in the color location can be compensated by the additional lighting means 140 also arranged in the light box 131. In the present example, to compensate the resulting shift in the color location, the additional lighting means 140 must have a radiant flux in the red spectral range whose amount can be changed by a corresponding control. The red radiation coming from the additional lighting means 140 is then mixed with the radiant flux of the CCFL fluorescent lamps 132, and thus the luminous flux seen by the user, either directly or by reflection from the sidewalls of the light box 131 and subsequently via the radiant surface A and the diffusing screen 20 is uniform and complete. By suitably controlling the additional lighting means 140, the red spectral color component is increased far enough until the color location of the luminous flux again corresponds to the color location for white. To adjust multiple color components, a corresponding number of differently colored additional lighting means 140 must be provided. Preferably, three additional lighting means, i.e., one with red, one with yellow and one with blue color components, are provided so that every possible shift of the color location can be compensated by mixing the color components accordingly. A corresponding control of the lighting means for the respective color components makes it possible to compensate any shift by color mixing.

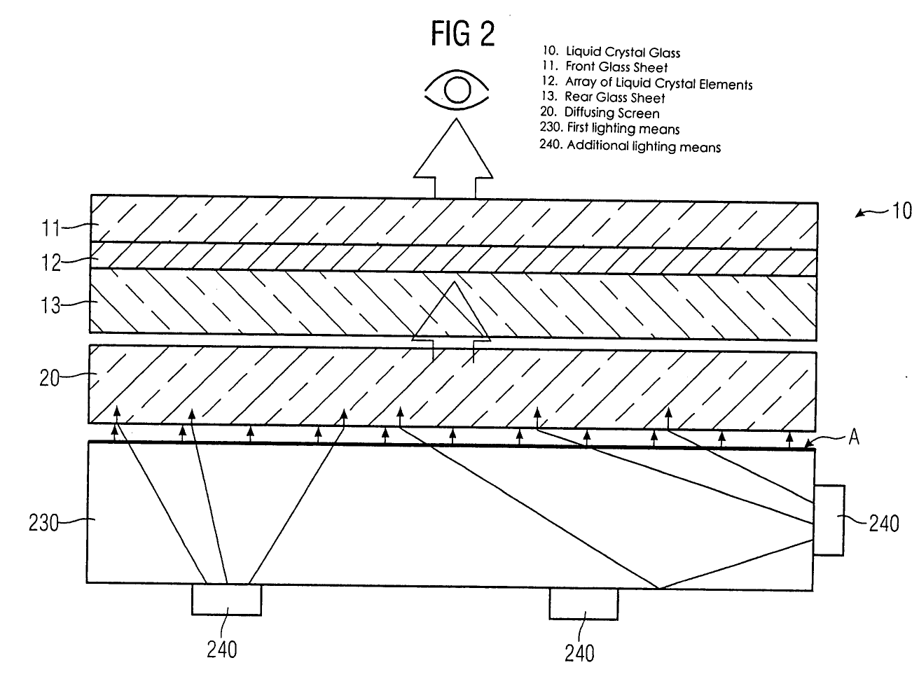

FIG. 2 shows the backlighting system for a liquid crystal display in accordance with the second, illustrative, non-limiting embodiment of the present invention. In contrast to the exemplary embodiment depicted in FIG. 1, this illustrative embodiment has a so-called Planon lamp as the first lighting means 230. Because this Planon lamp is already a flat lamp with a radiant surface A, the guidance of the radiation, e.g., by means of a light box or other reflectors, can be eliminated. This exemplary backlighting system also has a diffusing screen 20 to scatter the radiation coming from the first lighting means 230. To change the color location of the luminous flux, three possible positions for the additional lighting means 240 are illustrated in FIG. 2. The additional lighting means 240 can be arranged along the side faces of the Planon lamp 230, such that the spectral radiant flux coming from the additional lighting means 240 is coupled to the Planon lamp 230.

The radiation of these additional lighting means 240 is correspondingly reflected on the sidewalls of the Planon lamp 230 and is directed to the liquid crystal glass 10 via the radiant surface A and the diffusing screen 20. The radiation from the additional lighting means 240 is then mixed with the luminous flux, as described above. Preferably, particularly in the liquid crystal displays with large display areas, the additional lighting means are arranged on the rear side of the Planon lamp to obtain a uniform mixing of their spectral color components across the entire display area.

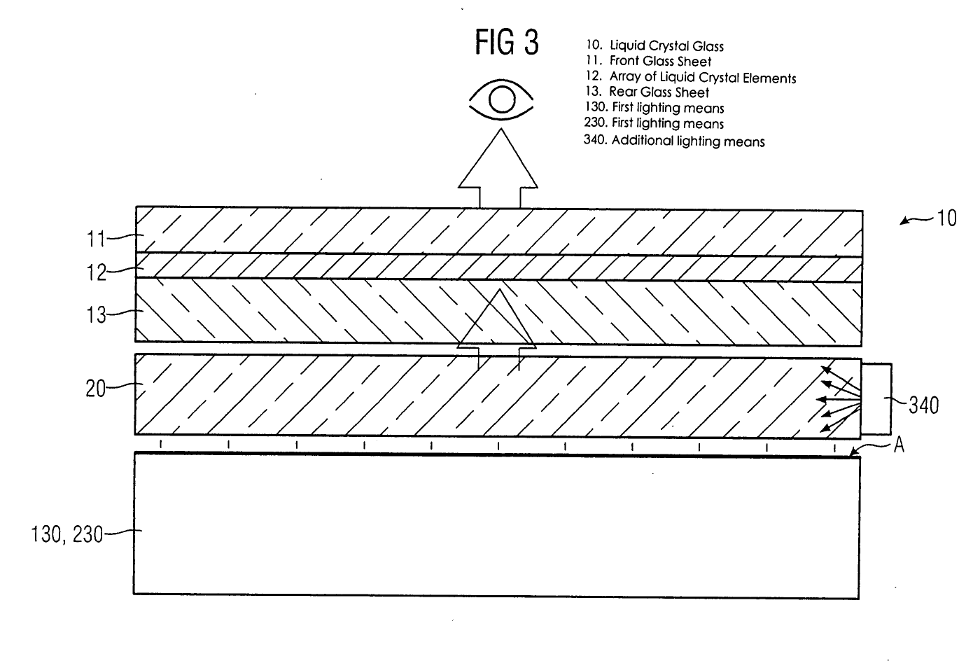

FIG. 3 shows a liquid crystal display with a backlighting system in accordance with the third illustrative, non-limiting embodiment of the present invention. As in the first two exemplary embodiments, the structure has a first lighting means 130 or 230, a diffusing screen 20 and a liquid crystal glass 10. In this embodiment, however, the additional lighting means 340 is arranged in such a way that the spectral radiant flux coming from the additional lighting means 340 is laterally coupled into the diffusing screen 20 and is thus almost uniformly distributed across the surface as it is supplied to the luminous flux.

The present invention, which has thus far been described with reference to the exemplary embodiments shown in FIG. 1 to 3, is not limited to those embodiments. Other embodiments, or even combinations of the described examples are possible, as long as the basic concept of the present invention is attained. It is feasible, for example, to couple a first additional lighting means 340 in the form of a light emitting diode with a blue color component to the diffusing screen 20, as depicted in FIG. 3, and to arrange two more lighting means 240 or 140 with yellow and red color components directly on the first lighting means, as depicted in FIG. 2 or 1.

The above description of the illustrative, non-limiting embodiments has been given by way of an example. The above and other features of the invention including various novel structures and a system of the various novel components have been particularly described with reference to the accompanying drawings and pointed out in the claims. It will be understood that the particular structure and construction of parts embodying the invention is shown by way of illustration only and not as a limitation of the invention. The principles and features of this invention may be employed in varied and numerous embodiments without departing from the scope of the invention as defined by the appended claims and equivalents thereof.

1. A backlighting system for a liquid crystal display comprising:
at least one first lighting means for illuminating a liquid crystal glass, said at least one first lighting means having a defined radiant flux with spectral color components at a first operating point, and the radiant flux output from the first lighting means, exiting across a first radiant surface of the backlighting system and resulting in a defined luminous flux with spectral color components on the liquid crystal glass arranged in front of the radiant surface; and
at least one additional lighting means with a variable radiant flux for illuminating the liquid crystal glass,
wherein said at least one additional lighting means is arranged such that the spectral color components of the luminous flux change when the radiation flux of said at least one additional lighting means is changed.

2. The backlighting system as claimed in claim 1, wherein said at least one first lighting means is a light box with a plurality of CCFL lamps arranged in the light box and with said at least one additional lighting means, and wherein said at least one additional lighting means is arranged such that the radiant flux of said at least one additional lighting means exits across the radiant surface.

3. The backlighting system as claimed in claim 1, wherein said at least one first lighting means comprises a fluorescent lamp.

4. The backlighting system as claimed in claim 3, wherein said at least one first lighting means is a light box with a plurality of CCFL lamps arranged in the light box and with said at least one additional lighting means, and wherein said at least one additional lighting means is arranged such that the radiant flux of said at least one additional lighting means exits across the radiant surface.

5. The backlighting system as claimed in claim 3, wherein said at least one first lighting means is a Planon lamp, and said at least one additional lighting means is arranged on one of the outer surfaces of the Planon lamp, such that the radiant flux from said at least one additional lighting means is coupled into the Planon lamp and exits across the radiant surface of the Planon lamp.

6. The backlighting system as claimed in claim 5, wherein said at least one additional lighting means is arranged on the outer surface of the Planon lamp that is opposite to the radiant surface.

7. The backlighting system as claimed in claim 1, wherein said at least one first lighting means is a Planon lamp, and said at least one additional lighting means is arranged on one of the outer surfaces of the Planon lamp, such that the radiant flux from said at least one additional lighting means is coupled into the Planon lamp and exits across the radiant surface of the Planon lamp.

8. The backlighting system as claimed in claim 7, wherein said at least one additional lighting means is arranged on the outer surface of the Planon lamp that is opposite to the radiant surface.

9. The backlighting system as claimed in claim 1, further comprising a diffusing screen arranged such that the radiant flux of said at least one first lighting means exiting across the radiant surface is scattered, and wherein said at least one additional lighting means is arranged on an outer surface of the diffusing screen such that the radiant flux from said at least one additional lighting means is coupled into the diffusing screen.

10. The backlighting system as claimed in claim 1, wherein the radiant flux of said at least one first lighting means is greater than the variable radiant flux of said at least one additional lighting means.

11. The backlighting system as claimed in claim 10, wherein said at least one additional lighting means is a light emitting diode.

12. The backlighting system as claimed in claim 1, wherein the radiant flux of said at least one additional lighting means has a defined spectral color component.

13. The backlighting system as claimed in claim 1, wherein said at least one additional lighting means compensates color location shifts of said at least one first lighting means.

14. A liquid crystal display comprising:
a liquid crystal glass; and
a backlighting system having a first lamp and a second lamp, the first lamp having a defined radiant flux with spectral color components at a first operating point, and the radiant flux exiting across a first radiant surface of the backlighting system and resulting in a defined luminous flux with spectral color components on the liquid crystal glass arranged in front of the radiant surface, and the second lamp having a variable radiant flux and arranged such that the spectral color components of the luminous flux change when the radiation flux of the second lamp is changed,
wherein the liquid crystal glass is configured such that colored pictures or monochrome pictures can be displayed, and wherein this display is influenced by the spectral color components of the luminous flux that are caused by the radiant flux of the first and second lamps.

15. The liquid crystal display as claimed in claim 14, wherein the liquid crystal display is configured to control and monitor in an automation system.

16. The liquid crystal display as claimed in claim 14, wherein the second lamp compensates color location shift of the first lamp.

17. The liquid crystal display as claimed in claim 14, wherein the backlighting system further comprises a light box with the first lamp and the second lamp, wherein the first lamp comprises a plurality of CCFL lamps, and wherein the second lamp is arranged such that the radiant flux of the second lamp exits across the radiant surface.

18. The liquid crystal display as claimed in claim 14, wherein the first lamp comprises a fluorescent lamp and wherein the second lamp comprises a light emitting diode.

19. The liquid crystal display as claimed in claim 14, wherein the luminous flux is mixed with the radiant flux from the second lamp, wherein the radiant flux from the second lamp is smaller than the radiant flux from the first lamp, and wherein a color location shift is compensated by the mixing.

20. The liquid crystal display as claimed in claim 14, wherein the second lamp is positioned on side walls of the first lamp, and wherein the first lamp is a Planton lamp.

21. The liquid crystal display as claimed in claim 14, wherein the backlighting system further comprises a diffusing screen scattering the radiant flux of the first lamp and wherein the second lamp is laterally coupled to the diffusing screen.
